(19) United States
(12) Patent Application Publication
(10) Pub. No.: US 2008/0257324 A1
(43) Pub. Date: Oct. 23, 2008

(54) INDUCTIVE IGNITION SYSTEM FOR INTERNAL COMBUSTION ENGINE

(75) Inventor: Michael FRENCH, Pleasant Prairie, WI (US)

Correspondence Address: OSLER, HOSKIN & HARCOURT LLP (BRP), 2100 - 1000 DE LA GAUCHETIERE ST. WEST, MONTREAL, QC, H3B4W5, CA

(73) Assignee: BRP US INC., Sturtevant, WI (US)

(21) Appl. No.: 11/957,632

(22) Filed: Dec. 17, 2007

Related U.S. Application Data
(60) Provisional application No. 60/871,683, filed on Dec. 22, 2006.

(51) Int. Cl. H01F 38/12

(52) U.S. Cl. 123/634; 701/102

(57) ABSTRACT

An inductive ignition system for an internal combustion engine is disclosed. The inductive ignition system includes an ignition coil having a primary coil and a secondary coil, the secondary coil providing high-voltage directly to a spark plug mounted in a cylinder of the internal combustion engine; the secondary coil having a rise time to its output voltage of less than 10 microseconds to deliver the high-voltage to the spark plug to produce a spark.

### CROSS-REFERENCE

The present application claims priority to U.S. Provisional Patent Application No. 60/871,683 filed on Dec. 22, 2006, the entirety of which is incorporated herein by reference.

### FIELD OF THE INVENTION

The present invention relates generally to inductive ignition system for internal combustion engine and in particular to high voltage inductive ignition system for internal combustion engine.

### BACKGROUND OF THE INVENTION

To reliably ignite the fuel-air mixture in the cylinders of an internal combustion engine, a fast rise time ignition spark potential is required and studies indicate that a long burn ignition arc provides improved fuel economy and engine idling characteristics. Because of practical ignition system parameter limitations, it has not been possible to provide an inductive ignition system having both fast rise time ignition spark potential and long burn ignition arc capabilities. For example, it has traditionally been impossible to provide an inductive type ignition system having fast rise time ignition spark potential capability for the reason that intolerably high ignition coil primary winding potential levels may occur during some conditions of operation. These intolerably high ignition coil primary winding potential levels may destroy the ignition coil or the ignition coil primary winding energizing circuit switching device. Consequently, it has been necessary to design the ignition coil with a secondary winding to primary winding turns ratio sufficiently high to prevent intolerably high primary winding reflected potentials.

Induction type ignition systems which interrupts a primary current flow through an ignition coil to produce a desired level of required secondary voltage for initiating an ignition arc through a spark plug typically include a transistor serving to turn on and off a primary current flowing through an ignition coil. The ignition coil has a primary winding connected to a collector electrode of the transistor and a secondary winding connected to a spark plug. A zener diode is connected to the transistor for protecting the transistor against the overvoltage. A breakdown voltage of the transistor is determined based on a zener voltage of the zener diode which is typically about 350 V depending on the effective withstand voltage characteristics of the transistor. The ignition coil of these prior art ignition systems exhibit relatively slow voltage rise to reach the ignition voltage of the spark plug. In other words, the ignition coil are characterized by a long voltage rise time to reach the ignition voltage of the spark plug. It is believed that if the coil secondary voltage rises too quickly, excessive high frequency energy is produced. This energy is then lost into the air-waves by electromagnetic radiation from the ignition wiring instead of going to the spark plugs. Consequently, voltage rise time should be more than 10 microseconds and conventional systems have a typical rise time of about 40 microseconds.

However, in internal combustion engine, spark plugs eventually become fouled with deposits of unburned gases and a long rise time to reach the ignition voltage of the spark plug increases the risk of misfiring by providing time for the voltage build-up of the ignition coil to leak through the deposits causing either an inadequate spark through the deposits on the sides of the spark plug electrodes instead of through the spark plug electrodes directly at the spark plug gap, or intermittent sparks which obviously negatively impact the performance and fuel economy of the engine. As illustrated in FIG. 3, a voltage rise time at the secondary coil in the order of 20 microseconds for a spark plug partially fouled with deposits provide the opportunity for energy to leak through the deposits. The graph of FIG. 3 shows a satisfactory voltage rise in the secondary coil in full line and an inadequate voltage rise in dotted lines. The dotted lines illustrates how energy leakage prevents the voltage of the secondary coil from reaching its maximum which leads to failure to initiate a spark causing misfiring in the combustion chamber. The inadequate firing or complete misfiring increases the incidence of fouled spark plugs, thereby aggravating the situation.

Thus, there is a need for an inductive ignition system that alleviates some of the drawbacks of conventional induction type ignition systems and preferably improves the performance and fuel economy of the engine.

### STATEMENT OF THE INVENTION

One aspect of the present invention is to provide an inductive ignition system for an internal combustion engine comprising an ignition coil including a primary coil and a secondary coil, the secondary coil providing high-voltage directly to a spark plug mounted in a cylinder of the internal combustion engine; an Electronic Control Unit (ECU), a transistor coupled between the primary coil and the ECU, and a voltage limiter coupled between the primary coil and the ECU in parallel with the transistor. The ECU controls the transistor to interrupt a current flow through the primary coil of the ignition coil at a predetermined timing to produce an output voltage in the secondary coil while the voltage limiter limits the voltage in the primary coil when the current flow through the primary coil is interrupted. The secondary coil having a rise time to its output voltage of less than 10 microseconds to deliver the high-voltage to the spark plug to produce a spark.

In another aspect, the voltage limiter is a zener diode limiting the voltage in the primary coil to at least 900 V.

In a further aspect, the zener diode limits the voltage in the primary coil to at least 1000 V.

In an additional aspect, the spark produced by the spark plug has a duration of at least 1.0 milliseconds.

In a further aspect, the secondary coil has a rise time to its output voltage of less than 5 microseconds.

In a further aspect of the present invention, the output voltage of the secondary coil is between 0V and 50,000V.

In a further aspect of the present invention, the output voltage of the secondary coil is between 4,000V and 40,000V.

Embodiments of the present invention each have at least one of the above-mentioned aspects, but not necessarily have all of them.

Additional and/or alternative features, aspects and advantages of the embodiments of the present invention will become apparent from the following description, the accompanying drawings and the appended claims.

### BRIEF DESCRIPTION OF THE DRAWINGS

For a better understanding of the present invention as well as other aspects and further features thereof, reference is made to the following description which is to be used in conjunction with the accompanying drawings, where:

FIG. 1 is a circuit diagram of an inductive ignition system in accordance with one embodiment of the invention;

FIG. 2 is a graphic representation of the voltage progression through one cycle in the primary and secondary coil of the inductive ignition system of FIG. 1;

FIG. 3 is a graphic representation of the voltage progression of a prior art ignition system; and

FIG. 4 is a circuit diagram of an inductive ignition system in accordance with second embodiment of the invention.

### DESCRIPTION OF PREFERRED EMBODIMENT(S)

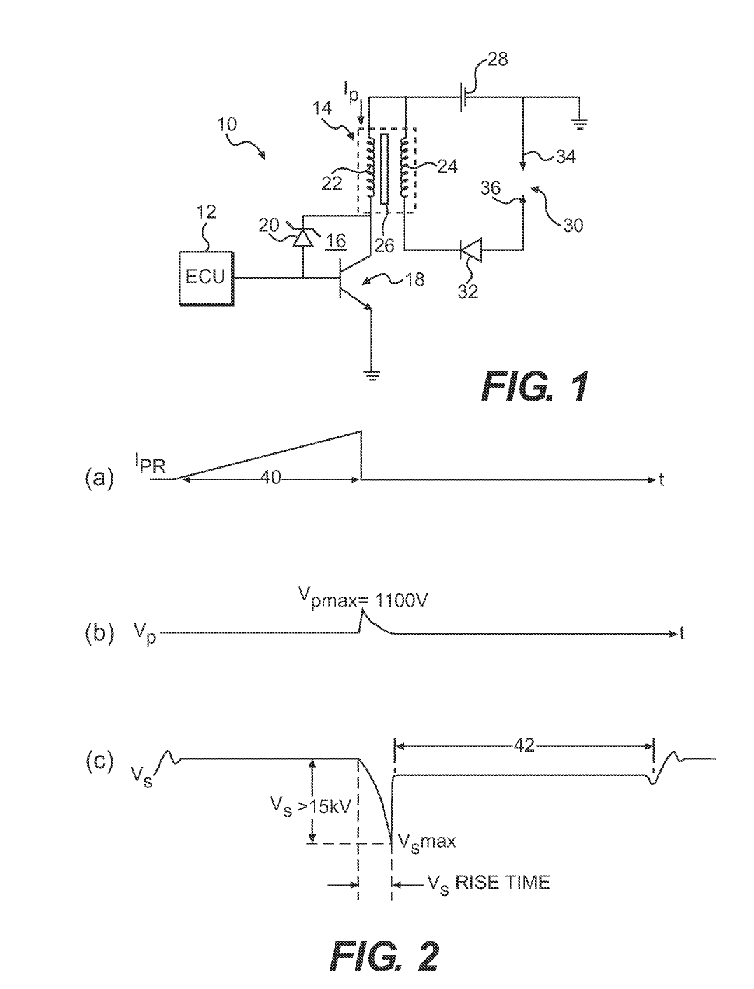

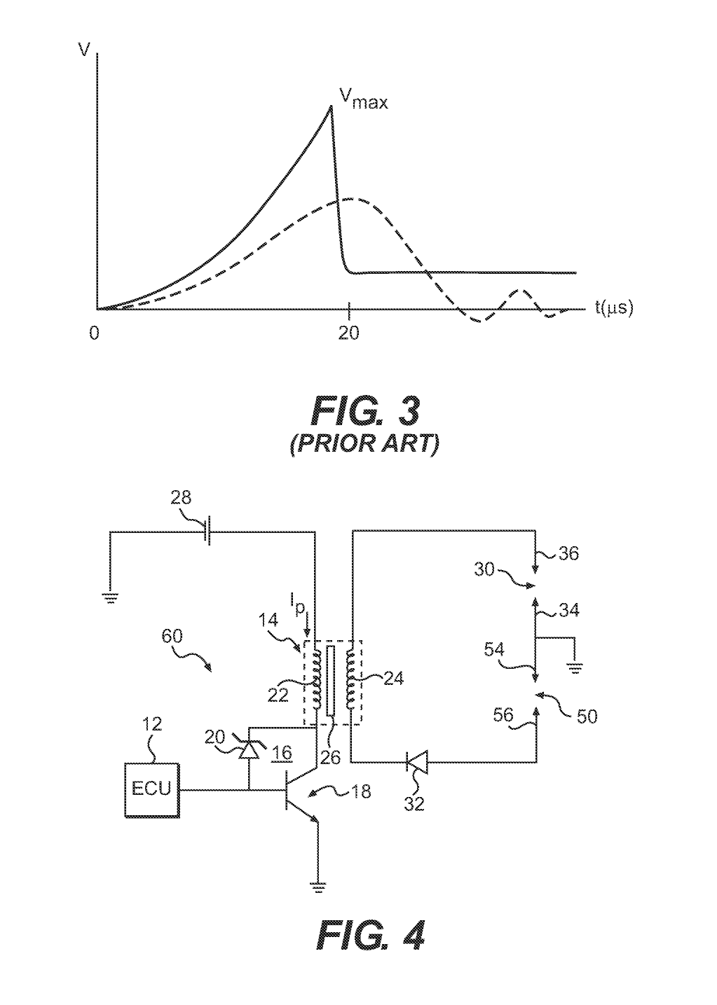

With reference to FIG. 1, an inductive ignition system 10 is shown. The inductive ignition system includes an electronic control unit (ECU) 12 incorporated in the engine management system of the engine, an ignition coil 14, and an ignition circuit 16 coupled between the ignition coil 14 and the ECU 12. The ignition coil 14 includes a primary coil 22, a secondary coil 24 coupled magnetically by an iron core 26. The ignition circuit 16 includes a transistor 18 and a voltage limiter 20 in the form of a zener diode. The transistor 18 and the voltage limiter 20 are connected in parallel to the primary coil 22 of the ignition coil 14. A battery 28 is connected to the ignition coil 14 and supplies electrical energy to the primary coil 22. The secondary coil 24 is connected to the spark plug 30. An activation arc diode 32 is provided between the secondary coil 24 and the spark plug 30 to prevent unwanted ignition. In the illustrated embodiment, the voltage limiter 20 is a zener diode however other voltage limiting device such as a comparator circuit may be used. The transistor 18 is an Insulated-Gate Bipolar Transistor (IGBT). However transistor 18 could be a simple bipolar transistor or a MOSFET.

In operation, the ECU 12 sends an electric signal to the transistor 18 at a predetermined timing to close the circuit and allow current Ip in the primary coil 22 of the ignition coil 14. The current rises in the primary coil 22 creating a magnetic field in the ignition coil 14 and energy is stored in the coil by this process. At a predetermined moment, the ECU 12 sends an electric signal to the transistor 18 open the circuit thereby cutting off the current Ip in the primary coil 22. The current cut-off causes the magnetic field to collapse which causes high voltage induction in the primary coil 22 and the secondary coil 24 of the ignition coil 14. While the voltage Vp induced in the primary coil 22 is in the order of several hundred volts, the voltage Vs induced in the secondary coil 24 is in the order of several thousand volts due to the much larger number of turns of the secondary coil. The ratio of turns between the secondary coil 24 and the primary coil 22 is in the order of 40:1. The high voltage Vs induced in the secondary coil 24 which is connected directly to the spark plug 30, in turn produces a spark between the electrodes 34 and 36 of the spark plug 30 and a spark current flows between the electrodes 34 and 36 as the spark duration increases until the spark is finally extinguished. At this point, the energy stored during the charging process has been fully converted.

The voltage limiter 20 protects the transistor 18 from a potential overvoltage of the voltage Vp induced in the primary coil 22 by controlling the voltage Vp allowed to reach the transistor 18, if the voltage Vp exceeds the set limit of the voltage limiter 20, a current flow is produced through the voltage limiter 20 so that current now flows though the primary coil 22 thereby reducing the voltage Vp with the effect of proportionally reducing the voltage Vs of the secondary coil 24. Typically, voltage limiters are set at voltages of about 450V to protects transistors from overvoltage.

It has however been discovered that allowing the induced voltage Vp to reach voltages of 900V and preferably 1000V, and more preferably 1100V increases the speed at which the secondary coil 24 reach the high voltage Vs required to produce a spark at the electrodes 34 and 36 of the spark plug 30 and substantially shortens its rise time. Furthermore, a shorter Vs rise time of the secondary coil 24 improves the ionisation process at the spark plug gap and ensures a long lasting spark which helps to ignite all the air/fuel mixture present in the combustion chamber.

As illustrated in FIG. 2 which graphically illustrates (a) the current Ipr going through the primary coil 22, (b) the progression of the voltage Vp of the primary coil 22 and (c) the progression of the voltage Vs of the secondary coil 24, through one ignition cycle. While the primary current circuit is closed (dwell period 40), current Ipr runs through the primary coil building up a magnetic field in the ignition coil 14. At the moment of ignition, the current Ipr through the primary coil 22 is interrupted causing the magnetic field to collapse and causing a voltage inductions in the primary coil 22 and the secondary coil 24. The voltage Vp in the primary coil 22 rises rapidly to the voltage limit Vpmax which is the voltage limit of the zener diode 20 and is set in this example at 1100V. Simultaneously, the voltage Vs in the secondary coil 24 also rises rapidly until Vs reaches the voltage demand of the spark plug 30 to ionize the gap between the electrodes 32 and 34 and initiate the spark which corresponds to Vsmax. When the spark occurs, the voltage Vs drops to a spark voltage of about 1000V to maintain the spark as a spark current flows and decreases as the spark duration 42 increases until the spark is finally extinguish. The spark duration 42 of the is in the range of 1.0 to 1.6 milliseconds. Vsmax varies according to the type of internal combustion engine in which the inductive ignition system 10 is being used. The range of Vsmax is between 0V and 50,000V and more preferably 4,000V and 40,000V.

Because the voltage limit of the zener diode 20 is set at 1100V, the voltage Vs rise time of the secondary coil 24 is considerably shortened relative to prior art system. In this particular embodiment, the rise time is about 3 microseconds. Setting the voltage limit of the zener diode 20 at 900V or more, ensures that the voltage Vs rise time of the secondary coil 24 is less than 10 microseconds and preferably less than 5 microseconds which substantially prevents energy leakage leading to inadequate firing or misfiring. The rapid voltage rise at the secondary coil 24 reduces the likelihood of leaking energy through the sides of the electrodes 32 and 34 ensuring efficient firing. The added benefit of a short rise time of the voltage Vs of the secondary coil 24 and of efficient firing, is that unburned gases are kept to a minimum and fouling of the spark plug is substantially diminished as the spark plug remains relatively clean and free of the accumulated deposits that would eventually provide pathways for energy to leak and cause misfiring.

FIG. 4 illustrate a second embodiment of the invention in which two spark plugs 30 and 50 are driven by a single ignition coil 14 also referred to as a double ended coil in the engine industry. As previously described, the ignition coil 14 includes a primary coil 22 and a secondary coil 24 coupled magnetically by an iron core 26. In the illustrated embodiment of FIG. 4, the secondary coil 24 is connected to the both spark plugs 30 and 50. The inductive ignition system 60 operates in exactly the same way as inductive ignition system 10 previously described with reference to FIG. 1 except that the high voltage Vs induced in the secondary coil 24 which is connected directly to the spark plugs 30 and 50, simultaneously produces a first spark between the electrodes 34 and 36 of the spark plug 30 and a second spark between the electrodes 54 and 56 of the spark plug 50. Current flows between the electrodes 34 and 36 and between the electrodes 54 and 56 as the sparks duration increase until the sparks are finally extinguished.

Modifications and improvement to the above described embodiments of the present invention may become apparent to those skilled in the art. The foregoing description is intended to be exemplary rather than limiting. Furthermore, the dimensions of features of various components that may appear on the drawings are not meant to be limiting, and the size of the components therein can vary from the size that may be portrayed in the figures herein. The scope of the present invention is therefore intended to be limited solely by the scope of the appended claims.

What is claimed is:

1- An inductive ignition system for an internal combustion engine comprising:
an ignition coil including a primary coil and a secondary coil, the secondary coil providing high-voltage directly to a spark plug mounted in a cylinder of the internal combustion engine;
an Electronic Control Unit (ECU),
a transistor coupled between the primary coil and the ECU, and
a voltage limiter coupled between the primary coil and the ECU in parallel with the transistor,
the ECU controlling the transistor to interrupt a current flow through the primary coil of the ignition coil at a predetermined timing to produce an output voltage in the secondary coil,
the voltage limiter limiting the voltage in the primary coil when the current flow through the primary coil is interrupted;
the secondary coil having a rise time to its output voltage of less than 10 microseconds to deliver the high-voltage to the spark plug to produce a spark.

2- An inductive ignition system as defined in claim 1 wherein the voltage limiter is a zener diode limiting the voltage in the primary coil to at least 900 V.

3- An inductive ignition system as defined in claim 2 wherein the zener diode limits the voltage in the primary coil to at least 1000 V.

4- An inductive ignition system as defined in claim 3 wherein the zener diode limits the voltage in the primary coil to at least 1100 V.

5- An inductive ignition system as defined in claim 1 wherein the spark produced by the spark plug has a duration of at least 1.0 milliseconds.

6- An inductive ignition system as defined in claim 1 wherein the output voltage of the secondary coil is between 0V and 50,000V.

7- An inductive ignition system as defined in claim 1 wherein the output voltage of the secondary coil is between 4,000V and 40,000V.

8- An inductive ignition system as defined in claim 1 wherein the secondary coil has a rise time to its output voltage of less than 5 microseconds.

9- An inductive ignition system as defined in claim 1 wherein the secondary coil providing high-voltage directly to two spark plugs mounted in a cylinder of the internal combustion engine

10- An inductive ignition system for an internal combustion engine comprising:
an ignition coil including a primary coil and a secondary coil, the secondary coil providing high-voltage directly to a spark plug mounted in a cylinder of the internal combustion engine;
an Electronic Control Unit (ECU),
a transistor coupled between the primary coil and the ECU, and
a zener diode coupled between the primary coil and the ECU in parallel with the transistor,
the ECU controlling the transistor to interrupt a current flow through the primary coil of the ignition coil at a predetermined timing to produce an output voltage in the secondary coil,
the zener diode limiting the voltage in the primary coil to at least 900V when the current flow through the primary coil is interrupted;
the secondary coil having a rise time to its output voltage of less than 10 microseconds to deliver the high-voltage to the spark plug to produce a spark.

11- An inductive ignition system as defined in claim 10 wherein the zener diode limits the voltage in the primary coil to at least 1000 V.

12- An inductive ignition system as defined in claim 10 wherein the secondary coil has a rise time to its output voltage of less than 5 microseconds.

13- An inductive ignition system as defined in claim 10 wherein the spark produced by the spark plug has a duration of at least 1.0 milliseconds.

14- An inductive ignition system as defined in claim 10 wherein the secondary coil providing high-voltage directly to two spark plugs mounted in a cylinder of the internal combustion engine
